(19) United States
(12) Patent Application Publication
(10) Pub. No.: US 2003/0054757 A1
(43) Pub. Date: Mar. 20, 2003

(54) Monitoring usage of media data with non-program data elimination

(76) Inventors: Ronald S. Kolessar, Elkridge, MD (US); Eugene L. Flanagan III, Wilton, CT (US)

Correspondence Address: ST. ONGE STEWARD JOHNSTON & REENS, LLC, 986 BEDFORD STREET, STAMFORD, CT, 06905-5619, US

(21) Appl. No.: 09/956,368

(22) Filed: Sep. 19, 2001

(51) Int. Cl. G06F 17/60; G06G 1/14; H04H 9/00

(52) U.S. Cl. 455/2.01; 705/22

(57) ABSTRACT

Systems and methods for monitoring usage of media data at user locations in which the presence or absence of media data in monitored data is determined. Where media data is present, it is separated from the monitored data and used to produce data representing usage of media data.

### FIELD OF THE INVENTION

The invention relates to systems and methods for monitoring usage of media data.

### BACKGROUND OF THE INVENTION

Existing techniques for determining the program to which an audience is exposed include pattern-matching and encoding techniques. Existing pattern matching techniques necessarily require a large amount of data to be processed to ensure reliable measurement. Encoding techniques involve adding a code to the media data. Encoding is not always practical in every instance and the necessary encoding and decoding equipment can become very complex.

Therefore, major concerns in audience measurement are the large amounts of data that must be stored and processed in order to obtain accurate measurements as well as the need to provide a simple and relatively inexpensive monitoring device.

### SUMMARY OF THE INVENTION

For this application the following terms and definitions shall apply, both for the singular and plural forms of nouns and for all verb tenses:

The term “data” as used herein means any indicia, signals, marks, domains, symbols, symbol sets, representations, and any other physical form or forms representing information, whether permanent or temporary, whether visible, audible, acoustic, electric, magnetic, electromagnetic or otherwise manifested.

The term “amplitude” as used herein refers to values of energy, power, voltage, current, charge, intensity, amount, size, magnitude and/or pressure, however measured or evaluated, whether on an absolute or relative basis, on a discrete or continuous basis, on an instantaneous or accumulated basis, or otherwise.

The term “media data” as used herein means data which is widely accessible, whether over-the-air, or via cable, satellite, network, internetwork (including the Internet), distributed on storage media, or otherwise, without regard to the form or content thereof, and including but not limited to audio data and video data.

The terms “audience” and “audience member” mean a person or persons, as the case may be, who access media data in any manner, whether alone or in one or more groups, whether in the same or various places, and whether at the same time or at various different times.

The terms “survey” and “surveying” mean an activity or activities, or conducting any such activity or activities, which gather data concerning usage of media data by an audience or an audience member, including but not limited to, data concerning the media data accessed and/or data concerning the audience or audience member.

The terms, “coupled”, “coupled to” and “coupled with” shall each mean a relationship between or among two or more devices, apparatus, files, programs, media, components, networks, systems, subsystems and/or means, constituting any one or more of (a) a connection whether direct or through one or more other devices, apparatus, files, programs, media, components, networks, systems, subsystems or means, (b) a communications relationship whether direct or through one or more other devices, apparatus, files, programs, media, components, networks, systems, subsystems, or means, or (c) a functional relationship in which the operation of any one or more thereof depends, in whole or in part, on the operation of any one or more others thereof.

The terms “communicate” and “communication” as used herein include both conveying data from a source to a destination, and delivering data to a communications medium, system or link to be conveyed to a destination.

The term “presence of media data” as used herein encompasses both the possible presence of media data, as well as the certain presence of media data.

The term, “processor” as used herein means processing devices, apparatus, programs, circuits, systems and subsystems, whether implemented in hardware, software or both.

The invention and its particular features and advantages will become more apparent from the following detailed description considered with reference to the accompanying drawings.

### BRIEF DESCRIPTION OF THE DRAWINGS

FIG. 1 is block diagram of an embodiment of a system for gathering data concerning media usage as well as for producing audience survey data.

FIG. 2 is a flow chart for use in explaining the operation of the FIG. 1 embodiment.

### DETAILED DESCRIPTION OF CERTAIN ADVANTAGEOUS EMBODIMENTS

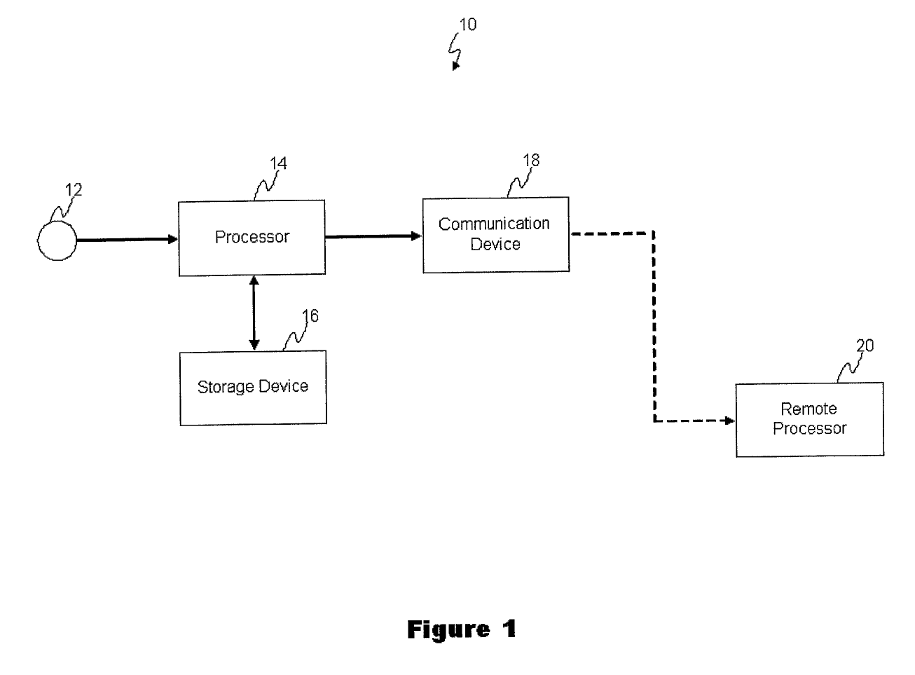

FIG. 1 is a block diagram for one embodiment of an audience measurement system 10 within the scope of the invention. A monitoring device 12 is provided for receiving monitored data. The monitoring device 12 can be either a single device, stationary at the source to be monitored, or multiple devices, stationary at the multiple sources to be monitored. Alternatively, the monitoring device 12 can be incorporated in a portable monitoring device that can be carried by an individual to monitor multiple sources as the individual moves about.

Where acoustic data including media data, such as audio data, is monitored, the monitoring device 12 typically would be a microphone having an input which receives media data in the form of acoustic energy and which serves to transduce the acoustic energy to electrical data. Where media data in the form of light energy, such as video data, is monitored, the monitoring device 12 takes the form of a light-sensitive device, such as a photodiode, or a video camera. Light energy including media data could be, for example, light emitted by a video display. The device 12 can also take the form of a magnetic pickup for sensing magnetic fields associated with a speaker, a capacitive pickup for sensing electric fields or an antenna for electromagnetic energy. In still other embodiments, the device 12 takes the form of an electrical connection to a monitored device, which may be a television, a radio, a cable converter, a satellite television system, a game playing system, a VCR, a DVD player, a portable player, a computer, a web appliance, or the like. In still further embodiments, the monitoring device 12 is embodied in monitoring software running on a computer or other reproduction system to gather media data.

A processor 14, coupled to the monitoring device 12, is provided for processing the monitored data. A storage device 16, coupled to processor 14, receives data from the processor 14 for storage. A communication device 18, coupled to the processor 14, is provided for transmitting the processed data. Finally, a processor 20 located remotely from the devices 14, 16 and 18 is coupled to the communication device 18 to receive data processed by the device 14 for evaluating the processed data.

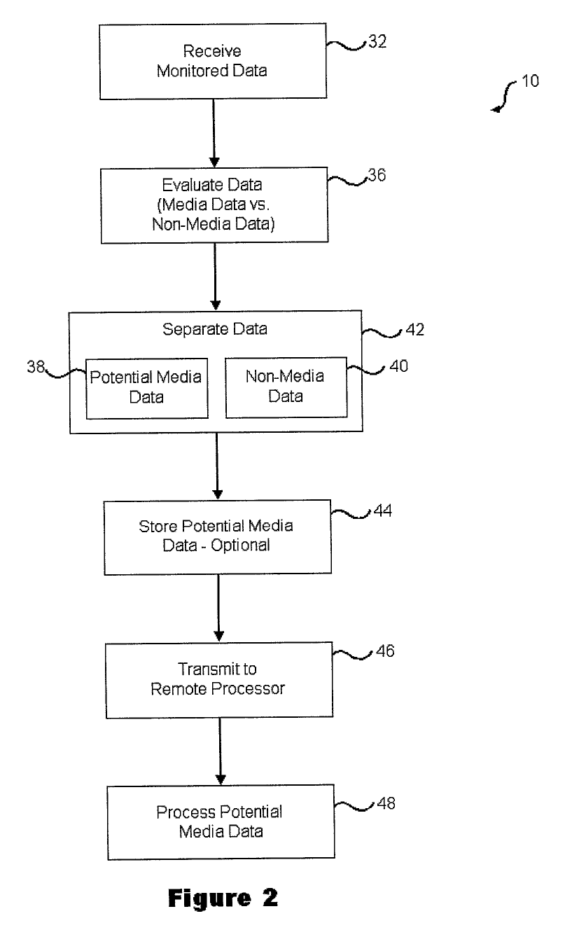

FIG. 2 is a flow diagram for use in explaining an operation of the system 10. As indicated at 32, the monitoring device 12 receives data, as explained above, and either supplies the data as received to the processor 14 or transforms the received data to a form usable by processor 14. The processor then carries out a procedure 36 to evaluate the data received from the device 12 in order to determine in which portions media data potentially is present and in which portions it is absent.

In one embodiment, the received data is divided into time segments and each time segment is separately evaluated for this purpose. In another embodiment, the data is divided into frequency segments and each is separately evaluated. In a further embodiment, the data is divided both in time and frequency and each division is separately evaluated.

In still another embodiment the data is divided by time and/or frequency and either separate divisions are evaluated alone or multiple divisions are evaluated in one or more stages. Each of the divisions, as well as the multiple divisions, as separately evaluated in any of the above embodiments is referred to herein as an “interval” of the data.

The evaluations 36 are conducted according to one or more techniques. In certain embodiments, the data is either received by processor 14 as frequency domain data or else transformed to a frequency domain. The frequency domain data is evaluated to determine whether it possesses characteristics of media data and/or noise characteristics. In other embodiments the data is received as time domain data or transformed to time domain data, and then evaluated for characteristics of media data and/or noise. In still other embodiments both time domain data and frequency domain data are evaluated.

In certain embodiments, the absence of media data is detected by analyzing the frequency content of the data for noise-like characteristics. Such characteristics include, but are not limited to, a relatively uniform amplitude of the data throughout a selected frequency spectrum or spectra and/or low amplitude levels. Also, the presence of noise is indicated by frequency content characteristic of machinery, power-line hum, or other types of ambient noise. Moreover, noise is often characterized by relatively little amplitude variability over time. Various embodiments of the invention utilize either one or more of these noise characteristics to determine that the data under evaluation is noise.

Acoustic or audio data constituting media data often include voice data and/or music data. Speech data typically is characterized by relatively few frequency components having amplitudes significantly higher than the noise level as well as by significant variability of data amplitude over time. Music data is often characterized by the prevalence of frequency components representing musical notes as well as amplitude variability over time characteristics of a meter of music. Video data is often characterized by well-defined periodicity at line, field and frame rates. Various embodiments of the invention utilize one or more of these media data characteristics to detect the potential presence of media data.

Still other embodiments of the invention utilize combinations of noise characteristics and media data characteristics to distinguish media data from noise.

Accordingly, in certain advantageous embodiments, the data is evaluated in a frequency domain to detect the potential presence of speech data or music data, or else video data, as appropriate. In certain techniques, data patterns are extracted from the data being evaluated, such as frequency content patterns and/or amplitude patterns over time in one or more frequency ranges, and matched with stored patterns representing known media data. In this manner, the potential presence of media data is determined. Such patterns include data sets, such as data representing amplitude variability over time or frequency, as well as overall amplitude levels over time and/or frequency. Similarly, the presence of noise is detected in certain embodiments based on matching of extracted data patterns with stored patterns representing noise.

In still other embodiments or in addition to the techniques described above, the presence of speech is detected by utilizing a speech recognition technique simply to detect data patterns characterizing speech, as opposed to the content of the speech.

Based on one or more of the foregoing evaluations, the processor 14 produces media data presence data which indicates the potential presence of media data in the evaluated data or its absence, in each of a plurality of the data intervals.

As indicated at 42, the processor 14 proceeds to separate intervals containing potential media data 38 from non-media data intervals 40. The separation process is carried out in any of a number of ways. In certain embodiments a tag is stored with each of the evaluated intervals in storage device 16 indicating whether it contains potential media data or non-media data. As new data is received, the processor 14 overwrites the non-media data based on its tag, while retaining the potential media data.

In other embodiments, only the potential media data is stored and/or communicated to the remote processor 20, as described below.

As indicated at 44, the processor 14 in certain embodiments stores the potential media data for subsequent communication to the remote processor by means of the communication device 16 in step 46. In other embodiments the processor 14 communicates the potential media data to the remote processor 20 once it is separated.

The remote processor 20 processes the received potential media data to produce audience survey data. In certain embodiments, the potential media data is processed by processor 20 to detect an audience survey code therein, which can serve to identify media data or its source or sources, or otherwise characterizes the media data or its relationship to other data. In other embodiments, the processor 20 processes the potential media data by matching it or a signature extracted therefrom with a known stored pattern or patterns, to identify the media data or its sources or sources, or else to derive some characteristic thereof or relationship to other data.

Although the invention has been described with reference to a particular arrangement of parts, features and the like, these are not intended to exhaust all possible arrangements or features, and indeed many other modification and variation will be ascertainable to those of skill in the art.

What is claimed is:

1. A system for producing audience survey data, comprising:
a first processor having an input to receive monitored data having intervals which include media data and intervals from which media data is absent, the first processor being operative to produce media data presence data each indicating whether media data potentially is present in a respective one of a plurality of monitored data sets each corresponding to a respective one of the intervals;
a monitored data separation subsystem coupled with the first processor to receive the media data presence data and an input to receive the monitored data, and operative to separate a first one of the monitored data sets in which media data potentially is present from a second one of the monitored data sets in which media data is absent based on the media data presence data; and
a second processor coupled with the monitored data separation subsystem to receive the first one of the monitored data sets and operative to produce audience survey data based on the first one of the monitored data sets.

2. The system of claim 1 wherein said second processor comprises a media data code decoder.

3. The system of claim 1 wherein said second processor comprises a pattern-matching system.

4. The system of claim 1 wherein the first processor is operative to extract a data pattern from the respective one of the plurality of monitored data sets and to produce the media data presence data based on the extracted data pattern.

5. The system of claim 1, wherein the monitored data separation subsystem comprises a data pattern production subsystem operative to produce a data pattern representing the first one of the monitored data sets in response to the media data presence data, and wherein the second processor is operative to match the data pattern with data patterns representing known media data to produce the audience survey data.

6. The system of claim 1, wherein the first processor is operative to evaluate the respective one of the plurality of monitored data sets in a frequency domain to determine whether media data potentially is present therein.

7. The system of claim 6, wherein the first processor is operative to determine whether media data potentially is present in the respective one of the plurality of monitored data sets by detecting the presence of speech data therein.

8. The system of claim 7, wherein the first processor is operative to detect the presence of speech data in the respective one of the plurality of monitored data sets using a speech recognition technique.

9. The system of claim 6, wherein the first processor is operative to determine whether media data potentially is present in the respective one of the plurality of monitored data sets by detecting the presence of music data therein.

10. The system of claim 6, wherein the first processor is operative to determine an absence of media data in the respective one of the plurality of monitored data sets by detecting the presence of noise therein.

11. The system of claim 10, wherein the first processor is operative to detect the presence of noise in the respective one of the plurality of monitored data sets based on a variability of data amplitudes thereof within the frequency domain.

12. The system of claim 1, wherein the first processor is operative to evaluate the potential presence of media data in the respective one of the plurality of monitored data sets based on a variability of data amplitudes thereof within a time domain.

13. The system of claim 1, further comprising a communications device coupled with the monitored data separation subsystem and with the second processor to communicate the first one of the monitored data sets from the monitored data separation subsystem to the second processor.

14. The system of claim 1, further comprising a storage subsystem coupled with the monitored data separation subsystem to receive the first one of the monitored data sets and operative to store the first one of the monitored data sets.

15. The system of claim 1, wherein the first processor and the monitored data separation subsystem are positioned at a user location and the second processor is positioned remotely from the user location.

16. The system of claim 15, further comprising a communications device coupled with the monitored data separation subsystem and with the second processor to communicate the first one of the monitored data sets from the monitored data separation subsystem to the second processor.

17. The system of claim 1, further comprising a sensor having an input to receive a signal to be monitored to produce the monitored data, the sensor being coupled to the first processor to provide the monitored data to the input thereof.

18. The system of claim 17, wherein the sensor is mounted on a personal portable monitoring device.

19. A system for producing audience survey data, comprising:
evaluating means for evaluating monitored data having intervals which include media data and intervals from which media data is absent, to produce media data presence data each indicating whether media data potentially is present in a respective one of a plurality of monitored data sets each corresponding to a respective one of the intervals;
separation means for separating a first one of the monitored data sets in which media data potentially is present from a second one of the monitored data sets in which media data is absent based on the media data presence data; and
means for producing audience survey data based on the first one of the monitored data sets.

20. The system of claim 19 wherein the evaluating means is operative to evaluate the respective one of the plurality of monitored data sets in a frequency domain to determine whether media data potentially is present therein.

21. The system of claim 19 wherein the means for producing audience survey data comprises means for decoding a media data code in the first one of the monitored data sets.

22. The system of claim 19 wherein the means for producing audience survey data comprises pattern matching means.

23. The system of claim 19 wherein the evaluating means is operative to extract a data pattern from the respective one of the plurality of monitored data sets and to match the extracted data pattern with a stored data pattern representing known media data to produce the media data presence data.

24. The system of claim 19, wherein the evaluating means is operative to determine whether media data potentially is present in the respective one of the plurality of monitored data sets by evaluating the respective one of the plurality of monitored data sets in a frequency domain to detect the presence of speech data therein.

25. The system of claim 24, wherein the evaluating means is operative to detect the presence of speech data in the respective one of the plurality of monitored data sets using a speech recognition technique.

26. The system of claim 19, wherein the evaluating means is operative to determine whether media data potentially is present in the respective one of the plurality of monitored data sets by evaluating the respective one of the plurality of monitored data sets in a frequency domain to detect the presence of music data therein.

27. The system of claim 19, wherein the evaluating means is operative to detect an absence of media data in the respective one of the plurality of monitored data sets by evaluating the respective one of the plurality of monitored data sets in a frequency domain to detect the presence of noise therein.

28. The system of claim 27, wherein the evaluating means is operative to detect the presence of noise in the respective one of the plurality of monitored data sets based on a variability of data amplitudes thereof within the frequency domain.

29. The system of claim 19, wherein the evaluating means is operative to evaluate the potential presence of media data in the respective one of the plurality of monitored data sets based on a variability of data amplitudes therein within a time domain.

30. The system of claim 19, further comprising communications means for communicating the first one of the monitored data sets from the separation means to the means for producing audience survey data.

31. The system of claim 19, further comprising storage means for storing the first one of the monitored data sets.

32. The system of claim 19 wherein the evaluating means and the separation means are positioned at a user location and the means for producing audience survey data is positioned remotely from the user location.

33. The system of claim 32, further comprising communications means for communicating the first one of the monitored data sets from the separation means to the means for producing audience survey data.

34. The system of claim 19, further comprising a sensor having an input to receive a signal to be monitored to produce the monitored data, the sensor being coupled to the evaluating means to provide the monitored data thereto.

35. The system of claim 34, wherein the sensor is mounted on a personal portable monitoring device.

36. A system for gathering data for monitoring usage of media data, comprising:
a first processor having an input to receive monitored data having intervals which include media data and intervals from which media data is absent, the first processor being operative to produce media data presence data indicating whether media data potentially is present in a respective one of a plurality of monitored data sets each corresponding to a respective one of the intervals; and
a monitored data separation subsystem coupled with the first processor to receive the media data presence data and an input to receive the monitored data, and operative to separate first monitored data in which media data potentially is present from second monitored data in which media data is absent based on the media data presence data.

37. The system of claim 36, wherein the first processor is operative to evaluate the respective one of the plurality of monitored data sets in a frequency domain to determine whether media data potentially is present therein.

38. The system of claim 37, wherein the first processor is operative to determine whether media data potentially is present in the respective one of the plurality of monitored data sets by evaluating the monitored data in the frequency domain to detect the presence of speech data therein.

39. The system of claim 38, wherein the first processor is operative to detect the presence of speech data using a speech recognition technique.

40. The system of claim 37, wherein the first processor is operative to determine whether media data potentially is present in the respective one of the plurality of monitored data sets by detecting the presence of music data therein.

41. The system of claim 37, wherein the first processor is operative to determine an absence of media data in the respective one of the plurality of monitored data sets by detecting the presence of noise therein.

42. The system of claim 41, wherein the first processor is operative to detect the presence of noise based on a variability of data amplitudes within the frequency domain of the respective one of the plurality of monitored data sets.

43. The system of claim 36, wherein the first processor is operative to evaluate the respective one of the plurality of monitored data sets in a time domain to determine whether media data potentially is present therein.

44. The system of claim 36, further comprising a storage subsystem coupled with the monitored data separation subsystem to receive the first monitored data and operative to store the first monitored data.

45. The system of claim 36, further comprising a communications device coupled with the monitored data separation subsystem and operative to communicate the first monitored data to a second processor located remotely from the monitored data separation subsystem for producing audience survey data based on the first monitored data.

46. The system of claim 36, further comprising a sensor having an input to receive a signal to be monitored to produce the monitored data, the sensor being coupled to the first processor to provide the monitored data to the input thereof.

47. The system of claim 46, wherein the sensor is mounted on a personal portable monitoring device.

48. A system for gathering data for monitoring usage of media data comprising:
evaluating means for evaluating monitored data having intervals which include media data and intervals from which media data is absent, to produce media data presence data indicating whether media data potentially is present in a respective one of a plurality of monitored data sets each corresponding to a respective one of the intervals; and
separation means for separating first monitored data in which media data potentially is present from second monitored data in which media data is absent based on the media data presence data.

49. The system of claim 48, wherein the evaluating means is operative to evaluate the respective one of the plurality of monitored data sets in a frequency domain to determine whether media data potentially is present therein.

50. The system of claim 49, wherein the evaluating means is operative to determine whether media data potentially is present in the respective one of the plurality of monitored data sets by detecting the presence of speech data therein.

51. The system of claim 50, wherein the evaluating means is operative to detect the presence of speech using a speech recognition technique.

52. The system of claim 49, wherein the evaluating means is operative to determine whether media data potentially is present in the respective one of the plurality of the monitored data sets by detecting the presence of music data therein.

53. The system of claim 49, wherein the evaluating means is operative to detect an absence of media data in the respective one of the plurality of the monitored data sets by detecting the presence of noise therein.

54. The system of claim 53, wherein the evaluating means is operative to detect the presence of noise based on a variability of data amplitudes in the respective one of the plurality of the monitored data sets within the frequency domain.

55. The system of claim 48, wherein the evaluating means is operative to evaluate the respective one of the plurality of the monitored data sets in a time domain to determine whether media data potentially is present therein.

56. The system of claim 48, further comprising storage means for storing the first monitored data.

57. The system of claim 48, further comprising communications means for communicating the first monitored data from the separation means to a processor located remotely from the separation means for producing audience survey data based on the first monitored data.

58. The system of claim 48, further comprising a sensor having an input to receive a signal to be monitored to produce the monitored data, the sensor being coupled to the evaluating means to provide the monitored data thereto.

59. The system of claim 58, wherein the sensor is mounted on a personal portable monitoring device.

60. A method for gathering data for producing audience survey data, comprising:
conducting an evaluation of monitored data having intervals which include media data and intervals from which media data is absent to determine whether media data potentially is present in the monitored data of each of a plurality of the intervals;
producing media data presence data indicating a potential presence of media data in the monitored data of each of the plurality of the intervals based on the evaluation; and
separating first monitored data in which media data potentially is present from second monitored data in which media data is absent based on the media data presence data.

61. The method of claim 60 further comprising the step of producing audience survey data based on the first monitored data.

62. The method of claim 60, wherein conducting an evaluation comprises evaluating the monitored data of each of the plurality of the intervals in a frequency domain to determine whether media data potentially is present therein.

63. The method of claim 60, wherein conducting an evaluation of the monitored data and producing media data presence data comprise extracting respective data patterns from the monitored data of each of the plurality of the intervals and matching the extracted data patterns with stored data patterns representing known media data to produce the media data presence data.

64. The method of claim 62, wherein conducting an evaluation comprises evaluating the monitored data of each of the plurality of the intervals in the frequency domain to detect the presence of music data therein.

65. The method of claim 62, wherein conducting an evaluation comprises evaluating the monitored data of each of the plurality of the intervals in the frequency domain to detect the presence of noise therein.

66. The method of claim 62, wherein conducting an evaluation comprises evaluating a variability of data amplitudes of the monitored data of each of the plurality of the intervals within the frequency domain to detect the presence of noise therein.

67. The method of claim 61, wherein conducting an evaluation comprises evaluating the monitored data of each of the plurality of the intervals in the frequency domain to detect the presence of speech data therein.

68. The method of claim 60, wherein conducting an evaluation comprises evaluating the monitored data of each of the plurality of the intervals in a time domain to determine whether media data potentially is present therein.
